(19) United States
(12) Patent Application Publication
(10) Pub. No.: US 2014/0283024 A1
(43) Pub. Date: Sep. 18, 2014

(54) Method for efficient behavioral analysis on a mobile station

(71) Applicant: QUALCOMM INCORPORATED, San Diego, CA (US)

(72) Inventors: Sudha Anil GATHALA, Sunnyvale, CA (US); Rajarshi Gupta, Sunnyvale, CA (US)

(73) Assignee: Qualcomm Incorporated, San Diego, CA (US)

(21) Appl. No.: 13/801,431

(22) Filed: Mar. 13, 2013

(51) Int. Cl. G06F 21/50

(52) U.S. Cl. CPC G06F 21/50
USPC 726/22

(57) ABSTRACT

Disclosed is a method for efficient behavioral analysis on a mobile station. In the method, one or more first behavioral characteristics associated with a first state of a finite state machine are observed. The one or more first behavioral characteristics may comprise a first subset of observable behavioral characteristics. The mobile station transitions from the first state to a second state. One or more second behavioral characteristics associated with the second state of the finite state machine are observed. The one or more second behavioral characteristics may comprise a second subset of the observable behavioral characteristics.

### BACKGROUND

1. Field

The present invention relates generally to efficient behavioral analysis on a mobile station.

2. Background

Detection of malware on a mobile station, such as a cellular telephone, is constrained by the device's limited resources (power, memory, bandwidth, etc.). Thus, PC-style signature matching on a mobile device is not an effective solution for malware detection and removal. An alternative is for a thin client on a device to generate a signature/hash of installed applications, and to forward the signature(s) to a network-based server for signature matching. Unfortunately, network-based signature matching generally fails to protect against “zero-day” attacks, or against web-applications and web-based malware.

Behavior analysis may be used to detect programs and applications that are actively malicious, or poorly written. However, performing behavioral analysis on a mobile station also may be challenging due to limited resources.

There is therefore a need for a technique for efficient behavioral analysis on a mobile station.

### SUMMARY

An aspect of the present invention may reside in a method for efficient behavioral analysis on a mobile station. In the method, one or more first behavioral characteristics associated with a first state of a finite state machine are observed. The one or more first behavioral characteristics may comprise a first subset of observable behavioral characteristics. The mobile station transitions from the first state to a second state. One or more second behavioral characteristics associated with the second state of the finite state machine are observed. The one or more second behavioral characteristics may comprise a second subset of the observable behavioral characteristics.

In more detailed aspects of the invention, the observable behavioral characteristics may comprise application program interfaces (APIs). The one or more first behavioral characteristics may be associated with transitions from the first state, and the one or more second behavioral characteristics may be associated with transitions from the second state.

In other more detailed aspects of the invention, the method may further include the mobile station transitioning from the second state to a third state. One or more third behavioral characteristics associated with a third state of the finite state machine may be observed. The one or more third behavioral characteristics may comprise a third subset of the observable behavioral characteristics. Also, the first state may comprise an initial state, and the third state may comprise a final state.

Another aspect of the invention may reside in mobile station, comprising: means for observing one or more first behavioral characteristics associated with a first state of a finite state machine, wherein the one or more first behavioral characteristics comprise a first subset of observable behavioral characteristics; means for transitioning from the first state to a second state; and means for observing one or more second behavioral characteristics associated with the second state of the finite state machine, wherein the one or more second behavioral characteristics comprise a second subset of the observable behavioral characteristics.

Another aspect of the invention may reside in a mobile station comprising a processor configured to: observe one or more first behavioral characteristics associated with a first state of a finite state machine, wherein the one or more first behavioral characteristics comprise a first subset of observable behavioral characteristics; transition from the first state to a second state; and observe one or more second behavioral characteristics associated with the second state of the finite state machine, wherein the one or more second behavioral characteristics comprise a second subset of the observable behavioral characteristics.

Another aspect of the invention may reside in a computer program product, comprising computer-readable medium, comprising: code for causing a computer to observe one or more first behavioral characteristics associated with a first state of a finite state machine, wherein the one or more first behavioral characteristics comprise a first subset of observable behavioral characteristics; code for causing a computer to transition from the first state to a second state; and code for causing a computer to observe one or more third behavioral characteristics associated with a third state of the finite state machine, wherein the one or more third behavioral characteristics comprise a third subset of the observable behavioral characteristics.

An aspect of the present invention may reside in a method for efficient behavioral analysis on a mobile station. In the method, one or more first behavioral characteristics associated with a first set of states of a finite state machine are observed. The one or more first behavioral characteristics may comprise a first subset of observable behavioral characteristics. The mobile station transitions from the first set of states to a second set of states. One or more second behavioral characteristics associated with the second set of states of the finite state machine are observed. The one or more second behavioral characteristics may comprise a second subset of the observable behavioral characteristics.

In more detailed aspects of the invention, the method may further include the mobile station transitioning from the second set of states to a third set of states. One or more third behavioral characteristics associated with the third set of states of the finite state machine may be observed. The one or more third behavioral characteristics comprise a third subset of the observable behavioral characteristics.

Another aspect of the invention may reside in a mobile station, comprising: means for observing one or more first behavioral characteristics associated with a first set of states of a finite state machine, wherein the one or more first behavioral characteristics comprise a first subset of observable behavioral characteristics; means for transitioning from the first set of states to a second set of states; and means for observing one or more second behavioral characteristics associated with the second set of states of the finite state machine, wherein the one or more second behavioral characteristics comprise a second subset of the observable behavioral characteristics.

Another aspect of the invention may reside in a mobile station comprising a processor configured to: observe one or more first behavioral characteristics associated with a first set of states of a finite state machine, wherein the one or more first behavioral characteristics comprise a first subset of observable behavioral characteristics; transition from the first set of states to a second set of states; and observe one or more second behavioral characteristics associated with the second set of states of the finite state machine, wherein the one or more second behavioral characteristics comprise a second subset of the observable behavioral characteristics.

Another aspect of the invention may reside in a computer program product, comprising computer-readable medium, comprising: code for causing a computer to observe one or more first behavioral characteristics associated with a first set of states of a finite state machine, wherein the one or more first behavioral characteristics comprise a first subset of observable behavioral characteristics; code for causing a computer to transition from the first set of states to a second set of states; and code for causing a computer to observe one or more second behavioral characteristics associated with the second set of states of the finite state machine, wherein the one or more second behavioral characteristics comprise a second subset of the observable behavioral characteristics.

### BRIEF DESCRIPTION OF THE DRAWINGS

FIG. 1 is a block diagram of an example of a wireless communication system.

FIG. 2 is a block diagram of an example of a mobile station for detecting malicious activity in conjunction with generic malicious behavior patterns received from a network-based server.

FIG. 3 is a block diagram of a finite state machine.

FIG. 4 is a flow diagram of a method for efficient behavioral analysis on a mobile station, according to the present invention.

FIG. 5 is another block diagram of a finite state machine.

FIG. 6 is a block diagram of a computer including a processor and a memory.

FIG. 7 is a block diagram of a finite state machine having bounding boxes for defining a set of states.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

With reference to FIG. 2, a security system 200 in a mobile station 102 may dynamically decide what to observe, and at what levels of detail, through efficient query mechanisms and through dynamic interaction of an analyzer 230 with an observer 240 having access to hardware, sensors, and drivers to enable efficient observation. Techniques for malicious activity detection in a mobile station are described in more detail in U.S. patent application Publication Ser. No. ______; (application Ser. No. 13/741,388, filed Jan. 15, 2013), which application is incorporated herein by reference. The malicious activity detection may involve observation of behavioral characteristics associated with application programming interfaces (APIs).

The observer 240 may observe the APIs to generate behavior signatures (e.g., vectors of real numbers or graphs). The analyzer 230 takes a behavior signature as an input and correlates the observations against models to perform behavior analysis.

With reference to FIG. 3, when using state-based behavior specifications, each behavior is specified in terms of a finite state machine with an initial state, a final state, and a set of intermediate states (states 1 through N). State transitions may correspond to API calls, or conditions based on API calls, and their parameters.

With further reference to FIGS. 4 and 5, an aspect of the present invention may reside in a method 400 for efficient behavioral analysis on a mobile station 102. In the method, one or more first behavioral characteristics (e.g., API1 and API2) associated with a first state 51 of a finite state machine 500 are observed (step 410). The one or more first behavioral characteristics may comprise a first subset of observable behavioral characteristics. The mobile station transitions from the first state S1 to a second state S2 (step 420). One or more second behavioral characteristics (e.g., API3) associated with the second state of the finite state machine are observed (step 430). The one or more second behavioral characteristics may comprise a second subset of the observable behavioral characteristics.

In more detailed aspects of the invention, the one or more first behavioral characteristics may be associated with transitions from the first state 51, and the one or more second behavioral characteristics may be associated with transitions from the second state S2.

In other more detailed aspects of the invention, the method may further include the mobile station 102 transitioning from the second state S2 to a third state S3. One or more third behavioral characteristics (e.g., API4 and API5) associated with a third state of the finite state machine 400 may be observed. The one or more third behavioral characteristics may comprise a third subset of the observable behavioral characteristics. Also, the first state may comprise an initial state, and the third state may comprise a final state.

The technique of the present invention uses incremental observation to provide a novel methodology to minimize resources incurred in performing the behavioral analysis at run-time. In essence, the technique pre-computes the question of what to observe next, bypassing the analyzer and thereby taking it out of the decision of what to observe next. The technique may minimize the observation overhead (number of API's being observed) based on state-based behavior specifications.

As an example, in FIG. 5, the total of observable APIs would be seven. Observing all of these APIs would incur much computation and memory/storage overhead. Using state-based incremental observation, at each stage, only those APIs that correspond to the outgoing transitions of the current state in each behavior would need to be observed/monitored. This may significantly reduce the observation overhead because, without the state-based incremental adaptation, all seven APIs would need to be observed all the time, incurring CPU and memory overhead.

With further reference to FIG. 6, a mobile station 102 may comprise a computer 600 that includes a processor 610, a storage medium 620 such as memory and/or a disk drive, a display 630, and an input such as a keypad 640, and a wireless connection 650.

Another aspect of the invention may reside in mobile station 102, comprising: means 610 for observing one or more first behavioral characteristics associated with a first state S1 of a finite state machine 500, wherein the one or more first behavioral characteristics comprise a first subset of observable behavioral characteristics; means 610 for transitioning from the first state to a second state S2; and means 610 for observing one or more second behavioral characteristics associated with the second state of the finite state machine, wherein the one or more second behavioral characteristics comprise a second subset of the observable behavioral characteristics.

Another aspect of the invention may reside in a mobile station 102 comprising a processor 610 configured to: observe one or more first behavioral characteristics associated with a first state S1 of a finite state machine 500, wherein the one or more first behavioral characteristics comprise a first subset of observable behavioral characteristics; transition from the first state to a second state S2; and observe one or more second behavioral characteristics associated with the second state of the finite state machine, wherein the one or more second behavioral characteristics comprise a second subset of the observable behavioral characteristics.

Another aspect of the invention may reside in a computer program product, comprising computer-readable medium 620, comprising: code for causing a computer 600 to observe one or more first behavioral characteristics associated with a first state S1 of a finite state machine 500, wherein the one or more first behavioral characteristics comprise a first subset of observable behavioral characteristics; code for causing a computer to transition from the first state to a second state S2; and code for causing a computer to observe one or more third behavioral characteristics associated with a third state of the finite state machine, wherein the one or more third behavioral characteristics comprise a third subset of the observable behavioral characteristics.

With further reference to FIG. 7, an aspect of the present invention may reside in a method for efficient behavioral analysis on a mobile station 102. In the method, one or more first behavioral characteristics (e.g., API1, API2 and API3) associated with a first set 710 of states of a finite state machine 700 are observed. The one or more first behavioral characteristics may comprise a first subset of observable behavioral characteristics. The mobile station transitions from the first set of states to a second set 720 of states. One or more second behavioral characteristics (e.g., API4, API5, API6 and API7) associated with the second set of states of the finite state machine are observed. The one or more second behavioral characteristics may comprise a second subset of the observable behavioral characteristics.

In more detailed aspects of the invention, the method may further include the mobile station 102 transitioning from the second set of states to a third set of states. One or more third behavioral characteristics associated with the third set of states of the finite state machine may be observed. The one or more third behavioral characteristics comprise a third subset of the observable behavioral characteristics.

This technique of using a bounding box incremental adaptation resolves to the basic incremental adaptation for bounding boxes with just one node in each. The bounding box may further address the observation overhead with the selection of appropriate bounding box sizes. The incremental observation technique of the invention has several benefits. The observation overhead may be limited to the APIs needed to continue constructing the behaviors of interest. The benefits may be multi-fold if certain APIs that generate significant log traffic can be filtered out once observed.

Another aspect of the invention may reside in a mobile station 102, comprising: means 610 for observing one or more first behavioral characteristics associated with a first set 710 of states of a finite state machine 700, wherein the one or more first behavioral characteristics comprise a first subset of observable behavioral characteristics; means 610 for transitioning from the first set of states to a second set 720 of states; and means 610 for observing one or more second behavioral characteristics associated with the second set of states of the finite state machine, wherein the one or more second behavioral characteristics comprise a second subset of the observable behavioral characteristics.

Another aspect of the invention may reside in a mobile station 102 comprising a processor 610 configured to: observe one or more first behavioral characteristics associated with a first set 710 of states of a finite state machine 700, wherein the one or more first behavioral characteristics comprise a first subset of observable behavioral characteristics; transition from the first set of states to a second set 720 of states; and observe one or more second behavioral characteristics associated with the second set of states of the finite state machine, wherein the one or more second behavioral characteristics comprise a second subset of the observable behavioral characteristics.

Another aspect of the invention may reside in a computer program product, comprising computer-readable medium 620, comprising: code for causing a computer 600 to observe one or more first behavioral characteristics associated with a first set 710 of states of a finite state machine 700, wherein the one or more first behavioral characteristics comprise a first subset of observable behavioral characteristics; code for causing a computer to transition from the first set of states to a second set 720 of states; and code for causing a computer to observe one or more second behavioral characteristics associated with the second set of states of the finite state machine, wherein the one or more second behavioral characteristics comprise a second subset of the observable behavioral characteristics.

With reference to FIG. 1, a wireless remote station (RS) 102 (e.g. a mobile station MS) may communicate with one or more base stations (BS) 104 of a wireless communication system 100. The wireless communication system 100 may further include one or more base station controllers (BSC) 106, and a core network 108. Core network may be connected to an Internet 110 and a Public Switched Telephone Network (PSTN) 112 via suitable backhauls. A typical wireless mobile station may include a handheld phone, or a laptop computer. The wireless communication system 100 may employ any one of a number of multiple access techniques such as code division multiple access (CDMA), time division multiple access (TDMA), frequency division multiple access (FDMA), space division multiple access (SDMA), polarization division multiple access (PDMA), or other modulation techniques known in the art.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both non-transitory computer-readable storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for behavioral analysis on a mobile station, comprising:
observing one or more first behavioral characteristics associated with a first state of a finite state machine, wherein the one or more first behavioral characteristics comprise a first subset of observable behavioral characteristics;
transitioning from the first state to a second state; and
observing one or more second behavioral characteristics associated with the second state of the finite state machine, wherein the one or more second behavioral characteristics comprise a second subset of the observable behavioral characteristics.

2. A method for behavioral analysis as defined in claim 1, wherein the observable behavioral characteristics comprise APIs.

3. A method for behavioral analysis as defined in claim 1, further comprising:
transitioning from the second state to a third state; and
observing one or more third behavioral characteristics associated with a third state of the finite state machine, wherein the one or more third behavioral characteristics comprise a third subset of the observable behavioral characteristics.

4. A method for behavioral analysis as defined in claim 1, wherein the first state comprises an initial state.

5. A method for behavioral analysis as defined in claim 1, wherein the third state comprises a final state.

6. A method for behavioral analysis as defined in claim 1, wherein the one or more first behavioral characteristics are associated with transitions from the first state, and the one or more second behavioral characteristics are associated with transitions from the second state.

7. A mobile station, comprising:
means for observing one or more first behavioral characteristics associated with a first state of a finite state machine, wherein the one or more first behavioral characteristics comprise a first subset of observable behavioral characteristics;
means for transitioning from the first state to a second state; and
means for observing one or more second behavioral characteristics associated with the second state of the finite state machine, wherein the one or more second behavioral characteristics comprise a second subset of the observable behavioral characteristics.

8. A mobile station as defined in claim 7, wherein the observable behavioral characteristics comprise APIs.

9. A mobile station as defined in claim 7, further comprising:
means for transitioning from the second state to a third state; and
means for observing one or more third behavioral characteristics associated with a third state of the finite state machine, wherein the one or more third behavioral characteristics comprise a third subset of the observable behavioral characteristics.

10. A mobile station as defined in claim 7, wherein the first state comprises an initial state.

11. A mobile station as defined in claim 7, wherein the third state comprises a final state.

12. A mobile station as defined in claim 7, wherein the one or more first behavioral characteristics are associated with transitions from the first state, and the one or more second behavioral characteristics are associated with transitions from the second state.

13. A mobile station, comprising:
a processor configured to:
observe one or more first behavioral characteristics associated with a first state of a finite state machine, wherein the one or more first behavioral characteristics comprise a first subset of observable behavioral characteristics;
transition from the first state to a second state; and
observe one or more second behavioral characteristics associated with the second state of the finite state machine, wherein the one or more second behavioral characteristics comprise a second subset of the observable behavioral characteristics.

14. A mobile station as defined in claim 13, wherein the observable behavioral characteristics comprise APIs.

15. A mobile station as defined in claim 13, wherein the processor is further configured to:
transition from the second state to a third state; and
observe one or more third behavioral characteristics associated with a third state of the finite state machine, wherein the one or more third behavioral characteristics comprise a third subset of the observable behavioral characteristics.

16. A mobile station as defined in claim 13, wherein the first state comprises an initial state.

17. A mobile station as defined in claim 13, wherein the third state comprises a final state.

18. A mobile station as defined in claim 13, wherein the one or more first behavioral characteristics are associated with transitions from the first state, and the one or more second behavioral characteristics are associated with transitions from the second state.

19. A computer program product, comprising:
computer-readable medium, comprising:
code for causing a computer to observe one or more first behavioral characteristics associated with a first state of a finite state machine, wherein the one or more first behavioral characteristics comprise a first subset of observable behavioral characteristics;
code for causing a computer to transition from the first state to a second state; and
code for causing a computer to observe one or more third behavioral characteristics associated with a third state of the finite state machine, wherein the one or more third behavioral characteristics comprise a third subset of the observable behavioral characteristics.

20. A computer program product as defined in claim 19, wherein the observable behavioral characteristics comprise APIs.

21. A computer program product as defined in claim 19, further comprising:
code for causing a computer to transition from the second state to a third state; and
code for causing a computer to observe one or more third behavioral characteristics associated with a third state of the finite state machine, wherein the one or more third behavioral characteristics comprise a third subset of the observable behavioral characteristics.

22. A computer program product as defined in claim 19, wherein the first state comprises an initial state.

23. A computer program product as defined in claim 19, wherein the third state comprises a final state.

24. A computer program product as defined in claim 19, wherein the one or more first behavioral characteristics are associated with transitions from the first state, and the one or more second behavioral characteristics are associated with transitions from the second state.

25. A method for efficient behavioral analysis on a mobile station, comprising:
observing one or more first behavioral characteristics associated with a first set of states of a finite state machine, wherein the one or more first behavioral characteristics comprise a first subset of observable behavioral characteristics;
transitioning from the first set of states to a second set of states; and
observing one or more second behavioral characteristics associated with the second set of states of the finite state machine, wherein the one or more second behavioral characteristics comprise a second subset of the observable behavioral characteristics.

26. A method for efficient behavioral analysis as defined in claim 25, wherein the observable behavioral characteristics comprise APIs.

27. A method for efficient behavioral analysis as defined in claim 25, further comprising:
transitioning from the second set of states to a third set of states; and
observing one or more third behavioral characteristics associated with the third set of states of the finite state machine, wherein the one or more third behavioral characteristics comprise a third subset of the observable behavioral characteristics.

28. A mobile station, comprising:
means for observing one or more first behavioral characteristics associated with a first set of states of a finite state machine, wherein the one or more first behavioral characteristics comprise a first subset of observable behavioral characteristics;
means for transitioning from the first set of states to a second set of states; and
means for observing one or more second behavioral characteristics associated with the second set of states of the finite state machine, wherein the one or more second behavioral characteristics comprise a second subset of the observable behavioral characteristics.

29. A mobile station as defined in claim 28, wherein the observable behavioral characteristics comprise APIs.

30. A mobile station as defined in claim 28, further comprising:
means for transitioning from the second set of states to a third set of states; and
means for observing one or more third behavioral characteristics associated with the third set of states of the finite state machine, wherein the one or more third behavioral characteristics comprise a third subset of the observable behavioral characteristics.

31. A mobile station, comprising:
a processor configured to:
observe one or more first behavioral characteristics associated with a first set of states of a finite state machine, wherein the one or more first behavioral characteristics comprise a first subset of observable behavioral characteristics;
transition from the first set of states to a second set of states; and
observe one or more second behavioral characteristics associated with the second set of states of the finite state machine, wherein the one or more second behavioral characteristics comprise a second subset of the observable behavioral characteristics.

32. A mobile station as defined in claim 31, wherein the observable behavioral characteristics comprise APIs.

33. A mobile station as defined in claim 31, wherein the processor is further configured to:
transitioning from the second set of states to a third set of states; and
observing one or more third behavioral characteristics associated with the third set of states of the finite state machine, wherein the one or more third behavioral characteristics comprise a third subset of the observable behavioral characteristics.

34. A computer program product, comprising:
computer-readable medium, comprising:
code for causing a computer to observe one or more first behavioral characteristics associated with a first set of states of a finite state machine, wherein the one or more first behavioral characteristics comprise a first subset of observable behavioral characteristics;
code for causing a computer to transition from the first set of states to a second set of states; and
code for causing a computer to observe one or more second behavioral characteristics associated with the second set of states of the finite state machine, wherein the one or more second behavioral characteristics comprise a second subset of the observable behavioral characteristics.

35. A computer program product as defined in claim 34, wherein the observable behavioral characteristics comprise APIs.

36. A computer program product as defined in claim 34, further comprising:
code for causing a computer to transition from the second set of states to a third set of states; and
code for causing a computer to observe one or more third behavioral characteristics associated with the third set of states of the finite state machine, wherein the one or more third behavioral characteristics comprise a third subset of the observable behavioral characteristics.
